(19) United States
(12) Patent Application Publication
(10) Pub. No.: US 2015/0122905 A1
(43) Pub. Date: May 7, 2015

(54) PASSIVE TANGENTIAL EJECTOR FOR AN EXHAUST NOZZLE OF A GAS TURBINE ENGINE

(71) Applicant: United Technologies Corporation, Hartford, CT (US)

(72) Inventors: Keegan M. Martin, Stafford Springs, CT (US); Robert H. Bush, Glastonbury, CT (US)

(73) Assignee: United Technologies Corporation, Hartford, CT (US)

(21) Appl. No.: 14/184,139

(22) Filed: Feb. 19, 2014

Related U.S. Application Data
(60) Provisional application No. 61/766,400, filed on Feb. 19, 2013.

(51) Int. Cl. F02K 1/12; F02K 1/18; F02K 1/80

(52) U.S. Cl. CPC F02K 1/1238; F02K 1/805; F02K 1/18; F05D 2270/20
USPC 239/1; 239/265.19

(57) ABSTRACT

A flap for a convergent/divergent nozzle system includes an ejector door movably mounted to an inner skin at a hinge.

This application claims priority to U.S. Patent Appln. No. 61/766,400 filed Feb. 19, 2013.

### BACKGROUND

The present disclosure relates to a gas turbine engine and, more particularly, to a nozzle system therefore.

Gas turbine engines, such as those which power modem military aircraft, include a compressor section to pressurize a supply of air, a combustor section to burn a hydrocarbon fuel in the presence of the pressurized air, and a turbine section to extract energy from the resultant combustion gases and generate thrust. Downstream of the turbine section, an augmentor section, or “afterburner”, is operable to selectively increase thrust. The increase in thrust is produced when fuel is injected into the core exhaust gases downstream of the turbine section and burned with the oxygen contained therein to generate a second combustion and passed through a variable area exhaust nozzle system.

A variable area exhaust nozzle such as a convergent/divergent (C/D) nozzle optimizes the thrust produced within the gas turbine engine by provision of a multitude of nozzle positions. The term “convergent-divergent” describes an exhaust nozzle having a convergent section upstream of a divergent section. Exhaust gases from the turbine section passes through the decreasing diameter convergent section before passing through the increasing diameter divergent section. Convergent/Divergent (C/D) exhaust nozzles may be configured for an augmented or un-augmented engine in a two or three dimensional configuration with or without the capability to vector.

The convergent section is pivotally connected to static structure and to the divergent section. The divergent section is pivotally connected to the convergent section and to an external fairing positioned radially outboard of the divergent section. The opposite end of the external fairing is pivotally attached to a static outer case which surrounds the nozzle.

The nozzle defines a throat or jet area and an exit area. The jet area is the minimum cross sectional area of the nozzle and is defined by the interface between an aft end of the convergent section and a forward end of the divergent section. The exit area is the cross sectional area measured at the aft most section of the nozzle. The area ratio of a nozzle is the exit area divided by the jet area. The area ratio range provides a general indicator of engine performance and an increase in the area ratio range results in more efficient engine performance with increased engine thrust, fuel efficiency and a decrease in actuator loads required to articulate the nozzle as the engine power setting increases.

The convergent and divergent sections generally include flaps and flap seals circumferentially disposed, attached to one of the other sections or to a structural member within the engine. The alternately disposed flaps and flap seals accommodate changes in jet area and nozzle axis skew (if the nozzle is vectorable) by sliding relative to and overlapping each other as the jet and exit areas decrease or increase.

### SUMMARY

A convergent/divergent nozzle system according to one disclosed non-limiting embodiment of the present disclosure includes an ejector door movably mounted to said inner skin at a hinge.

A further embodiment of the present disclosure includes, wherein said ejector door is pressure balanced to open when a pressure of a secondary airflow is greater than a pressure of the core primary airflow.

A further embodiment of any of the foregoing embodiments of the present disclosure includes, wherein said ejector door is mechanically biased.

A further embodiment of any of the foregoing embodiments of the present disclosure includes, wherein said ejector door include a chiseled aft end section.

A further embodiment of any of the foregoing embodiments of the present disclosure includes an outer skin mounted to said inner skin to define a flowpath therethrough.

A convergent/divergent nozzle system according to another disclosed non-limiting embodiment of the present disclosure includes a divergent section downstream of said convergent section, said divergent section includes a passive tangential ejector.

A further embodiment of any of the foregoing embodiments of the present disclosure includes, wherein said divergent section is axisymmetric.

A further embodiment of any of the foregoing embodiments of the present disclosure includes, wherein said passive tangential ejector includes a passive tangential ejector in at least one divergent flap of said divergent section.

A further embodiment of any of the foregoing embodiments of the present disclosure includes, wherein said passive tangential ejector includes an ejector door with a chiseled aft end section.

A further embodiment of any of the foregoing embodiments of the present disclosure includes, wherein said passive tangential ejector is one of a multiple of passive tangential ejectors, each of said multiple of passive tangential ejectors is located in each of a multiple of divergent flaps of said divergent section.

A further embodiment of any of the foregoing embodiments of the present disclosure includes, wherein said passive tangential ejector includes an ejector door with a chiseled aft end section.

A further embodiment of any of the foregoing embodiments of the present disclosure includes, wherein said ejector door is mechanically biased.

A further embodiment of any of the foregoing embodiments of the present disclosure includes, wherein said passive tangential ejector is one of a multiple of passive tangential ejectors, each of said multiple of passive tangential ejectors is located in each of a multiple of divergent flaps of said divergent section.

A method of operating a convergent/divergent nozzle system according to another disclosed non-limiting embodiment of the present disclosure includes opening a divergent section of the convergent/divergent nozzle system to a secondary airflow.

A further embodiment of any of the foregoing embodiments of the present disclosure includes communicating ambient airflow as the secondary airflow.

A further embodiment of any of the foregoing embodiments of the present disclosure includes communicating fan airflow as the secondary airflow.

A further embodiment of any of the foregoing embodiments of the present disclosure includes communicating third stream airflow as the secondary airflow.

A further embodiment of any of the foregoing embodiments of the present disclosure includes opening a passive tangential ejector within the divergent section.

A further embodiment of any of the foregoing embodiments of the present disclosure includes opening a passive tangential ejector within a divergent flap of the divergent section.

A further embodiment of any of the foregoing embodiments of the present disclosure includes pressure balancing a passive tangential ejector within the divergent section between a core primary airflow and the secondary airflow.

### BRIEF DESCRIPTION OF THE DRAWINGS

Various features will become apparent to those skilled in the art from the following detailed description of the disclosed non-limiting embodiment. The drawings that accompany the detailed description can be briefly described as follows:

FIG. 1 is a general schematic view of an exemplary gas turbine engine with a nozzle section according to one disclosed non-limiting embodiment;

FIG. 2 is a lateral cross section of an exhaust duct section according to one non-limiting embodiment;

FIG. 3 is a lateral cross section of an exhaust duct section according to another non-limiting embodiment;

FIG. 4 is a lateral cross section of an exhaust duct section according to another non-limiting embodiment;

FIG. 5 is an exhaust duct section according to another non-limiting embodiment;

FIG. 6 is an exhaust duct section according to another non-limiting embodiment;

FIG. 7 is a general sectional side view of a variable geometry exhaust nozzle with the nozzle shown in a minimum position, the nozzle being illustrated on only one side of its centerline;

FIG. 8 is a partial sectional perspective view of the variable geometry exhaust nozzle with the nozzle shown in the minimum position which corresponds with FIG. 7;

FIG. 9 is a general sectional side view of a variable geometry exhaust nozzle with the nozzle shown in a maximum position and a passive tangential ejector (PTE) at least partially open, the nozzle being illustrated on only one side of its centerline; and

FIG. 10 is a general perspective view of a divergent section of the variable geometry exhaust nozzle from a cold side with an inner skin and hardware removed to show the passive tangential ejector (PTE) according to one disclosed non-limiting embodiment.

### DETAILED DESCRIPTION

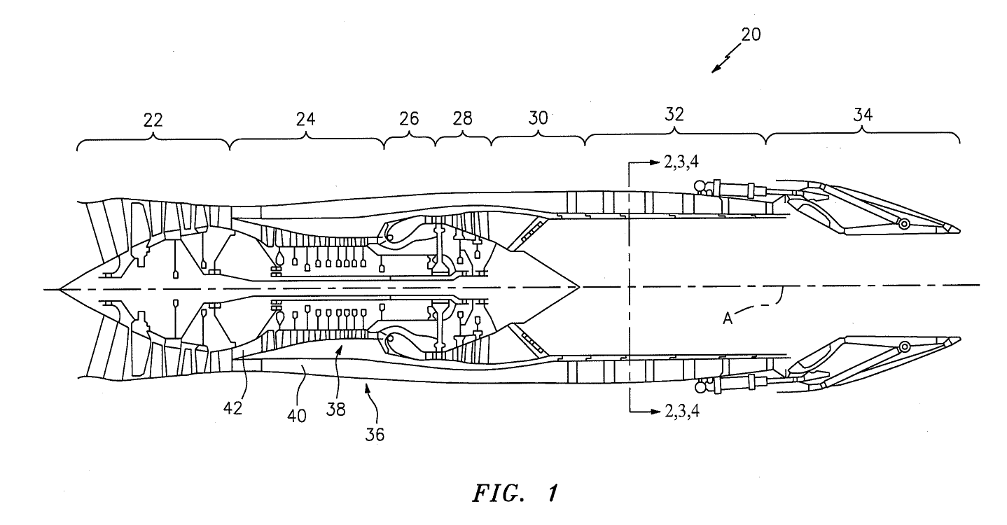

FIG. 1 schematically illustrates a gas turbine engine 20. The gas turbine engine 20 is disclosed herein as a two-spool low-bypass augmented turbofan that generally incorporates a fan section 22, a compressor section 24, a combustor section 26, a turbine section 28, an augmenter section 30, an exhaust duct section 32, and a nozzle system 34 along a central longitudinal engine axis A. Although depicted as an augmented low bypass turbofan in the disclosed non-limiting embodiment, it should be understood that the concepts described herein are applicable to other gas turbine engines including non-augmented engines, geared architecture engines, direct drive turbofans, turbojet, turboshaft, multi-stream variable cycle and other engine architectures with a nozzle system.

An outer structure 36 and an inner structure 38 define a generally annular secondary airflow path 40 around a core primary airflow path 42. Various structure and modules may define the outer structure 36 and the inner structure 38 which essentially define an exoskeleton to support the rotational hardware therein.

Air that enters the fan section 22 is divided between a core primary airflow through the core primary airflow path 42 and a secondary airflow through a secondary airflow path 40. The core primary airflow passes through the combustor section 26, the turbine section 28, then the augmentor section 30 where fuel may be selectively injected and burned to generate additional thrust through the nozzle system 34. It should be appreciated that additional airflow streams such as third stream airflow typical of variable cycle engine architectures may additionally be sourced from the fan section 22.

The secondary airflow may be utilized for a multiple of purposes to include, for example, cooling and pressurization. The secondary airflow as defined herein is any airflow different from the core primary airflow. The secondary airflow may ultimately be at least partially injected into the core primary airflow path 42 adjacent to the exhaust duct section 32 and the nozzle system 34.

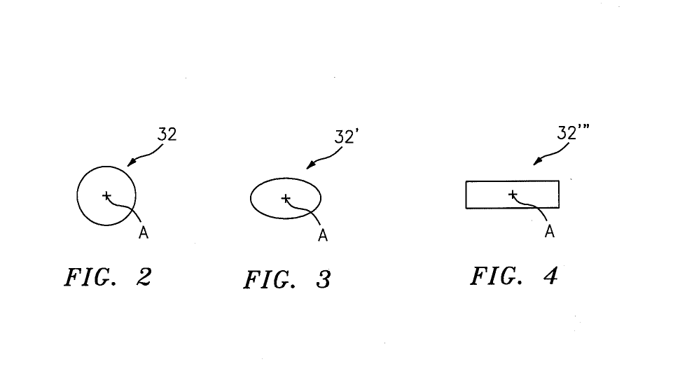

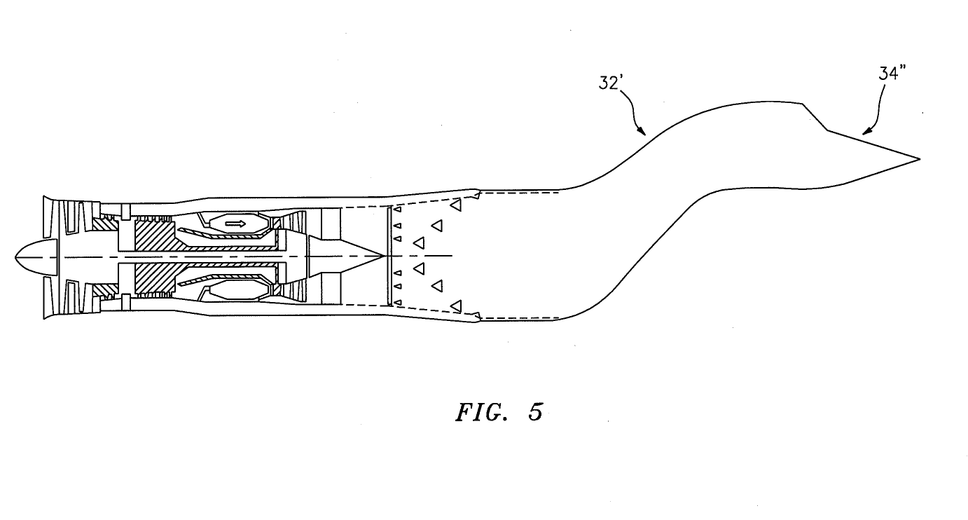

With reference to FIG. 2, the exhaust duct section 32 may be circular in cross-section as typical of an axisymmetric augmented low bypass turbofan. In another disclosed non-limiting embodiment the exhaust duct section 32′ may be non-axisymmetric in cross-section to include, but not be limited to, an oval cross-section (FIG. 3) or a rectilinear cross-section (FIG. 4). In addition to the various cross-sections, the exhaust duct section 32′ may be non-linear with respect to the central longitudinal engine axis A to form, for example, a serpentine shape to block direct view to the turbine section 28 (FIG. 5).

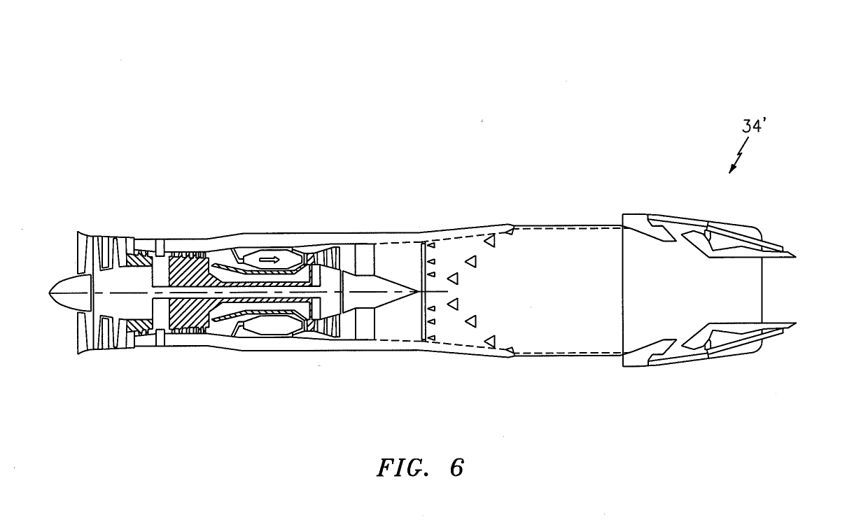

In addition to the various cross-sections and the various longitudinal shapes, the exhaust duct section 32 may terminate in a Convergent/Divergent (C/D) nozzle system 34 (FIG. 1), a non-axisymmetric two-dimensional (2D) C/D vectorable nozzle system 34 (FIG. 6), a flattened slot nozzle of high aspect ratio 34″ (FIG. 5) or other nozzle arrangement.

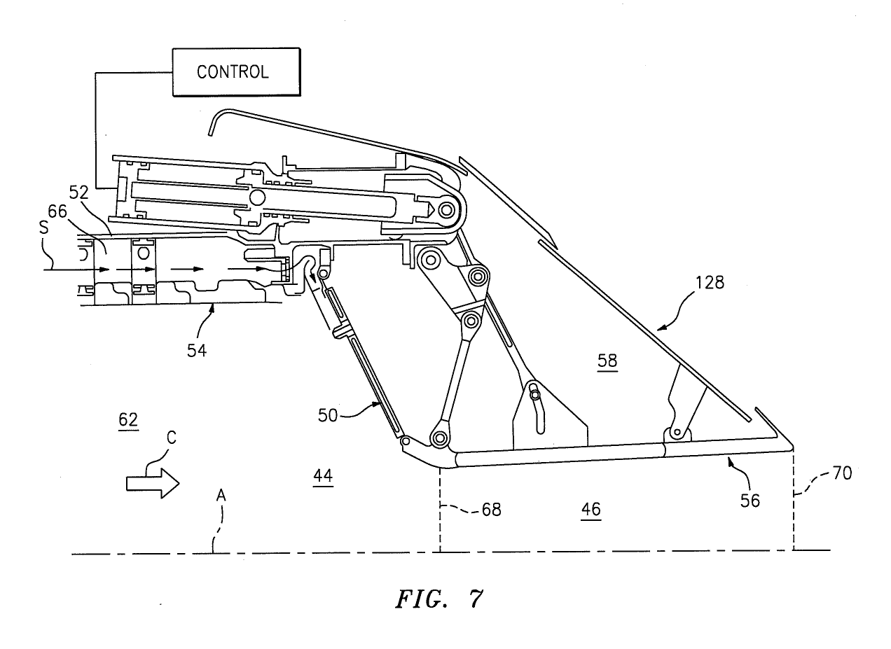

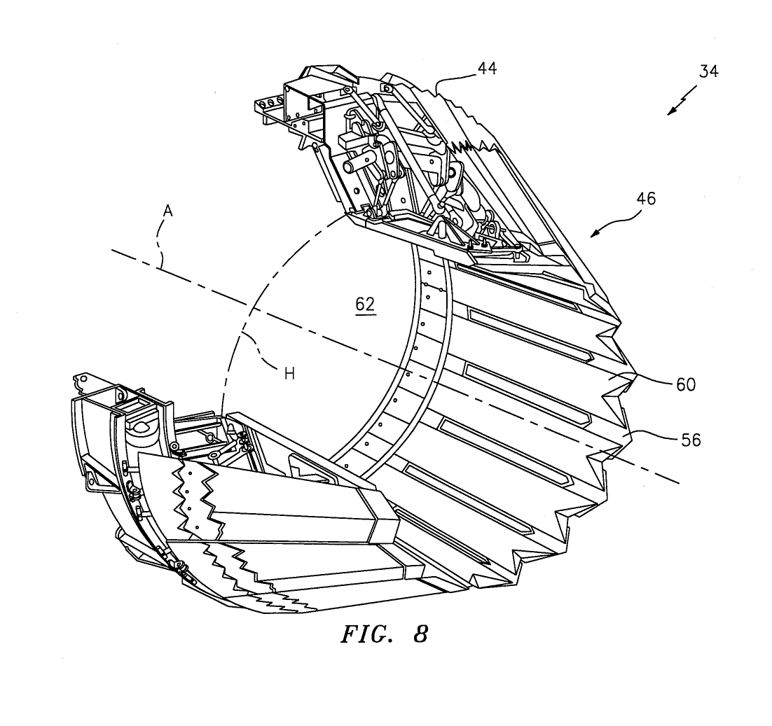

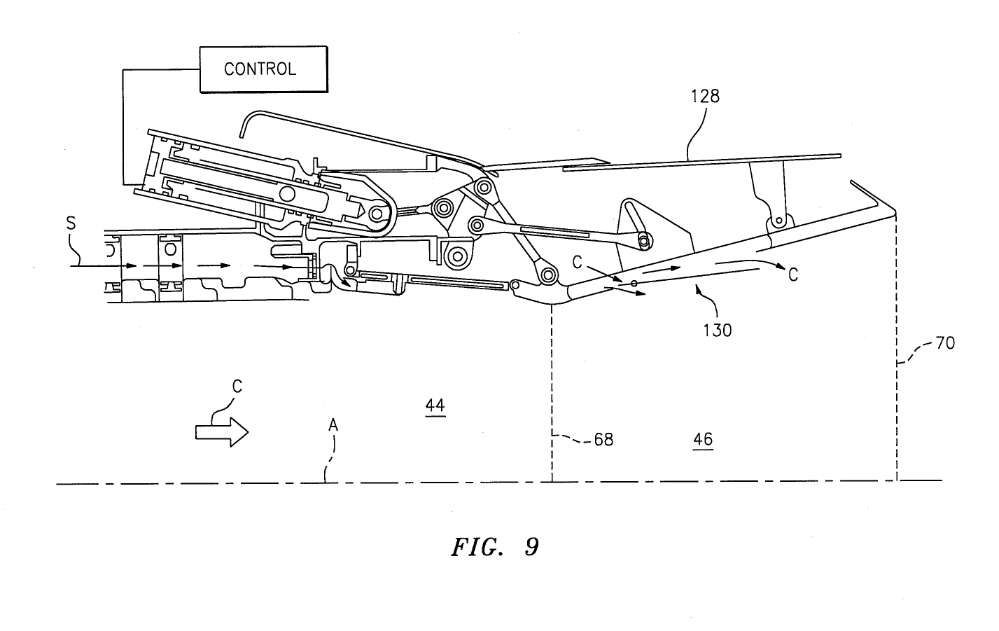

With reference to FIG. 7, the Convergent/Divergent (C/D) nozzle system 34 generally includes a convergent section 44 and a divergent section 46. The convergent section 44 includes a multiple of circumferentially distributed convergent flaps 50 (only one shown in section), each pivotably connected to a stationary frame 52 with a cooling liner panel 54 upstream thereof. The divergent section 46 includes a multiple of circumferentially distributed divergent flaps 56 (only one shown in section) pivotably connected at a joint 58 to an aft end section of the convergent flaps 50. A plurality of divergent flap seals 60 (FIG. 8) are distributed circumferentially between the divergent flaps 56. Taken collectively, the convergent and divergent flaps 50, 56 and the inter-flap seals 60 circumscribe the nozzle centerline A to define the radial outer boundary of an exhaust gas path 62. During operation, a control system governs the angular orientations of the convergent flaps 50 and divergent flaps 56 to adjust a nozzle throat A8 and exit A9 about a nozzle centerline A between a minimum position (FIG. 7) and a maximum position (FIG. 9).

The liner panels 54, taken collectively, form a liner that cooperates with the convergent flaps 50 to define an annular cooling airflow passageway 66. The passageway 66 guides the secondary airflow (illustrated schematically be arrows S) along an annular inner surface of the convergent flaps 50. The cavity airflow C is typically sourced from the fan section 22, the compressor section 24, a third stream airflow, ambient airflow and/or other airflow that is different from the core primary airflow (illustrated schematically by arrow C).

The nozzle system 34 defines a nozzle throat 68 or jet area that forms the minimum cross sectional area of the nozzle system 34 and defines the mass flow W8 therethrough. The nozzle throat 68 compared to the nozzle exit 70 defines a nozzle area ratio. As the operating pressure entering the convergent section 44 increases, an increased area ratio (exit area/jet area) results in more efficient nozzle operation. An increased area ratio range thus allows more efficient engine performance with increased engine thrust, increased fuel efficiency and reduced actuator loads required to articulate the nozzle system 34.

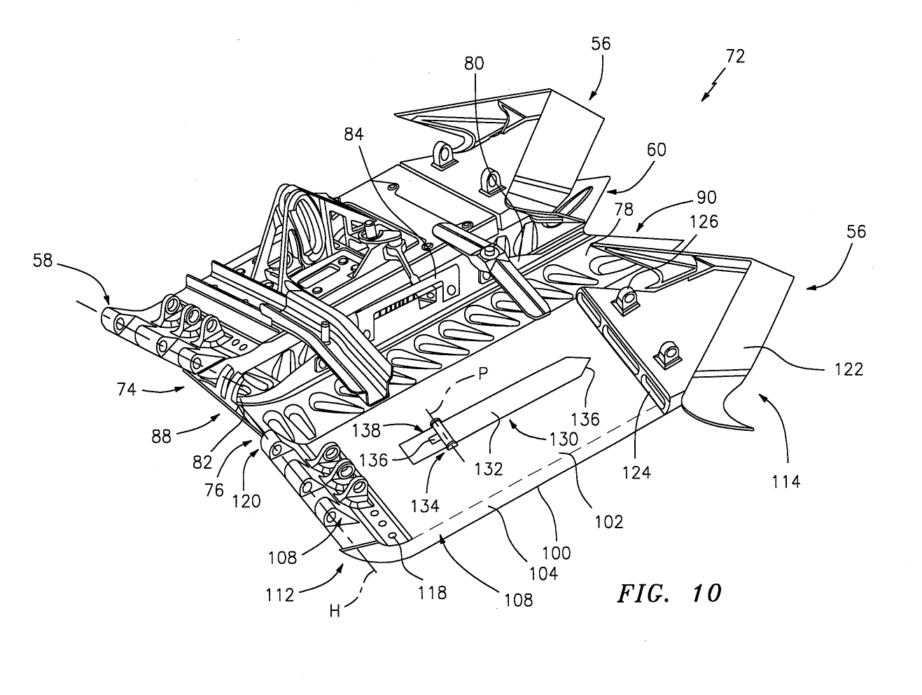

With reference to FIG. 10, a divergent flap section 72 includes one divergent flap seal 60 with one divergent flap 56 mounted along each longitudinal side 74, 76 thereof. It should be understood that the flap section 72 as illustrated herein is for descriptive purposes only and applies to each adjacent flap 56 and flap seal 60 defined about the circumference of the nozzle system 34. The flap section 72 is illustrated from a side opposite the hot-side which is directly exposed to engine exhaust gases. The cold-side of the flap section 72 is defined as the side generally opposite the exhaust gas path.

Each divergent flap seal 60 includes a flap seal body 78, a spine member 80, a flap seal joint structure 82 and a flap seal position guide 84. The flap seal joint structure 82 forms a portion of the joint 58 which defines a hinge axis H that surrounds the engine centerline A. Each flap seal body 78 may be described as having a length between a forward end section 88 and an aft end section 90, and a width between the first longitudinal side 74 and the second longitudinal side 76. The flap seal body 78 is a relatively planar member having a multitude of structural corrugations or the like. In other words, in this non-limiting embodiment, the flap seals 60 are generally stamped members and are hollow as are the divergent flaps 56. The aft end section 50 may be of a chiseled shape to form a serrated nozzle end.

Each divergent flap 56 of this non-limiting embodiment includes a divergent flap hot-side inner skin 100 and a cold-side outer skin 102. The skins 100, 102 form an at least partially hollow interior with one or more channels 104 which receive the secondary airflow S therethrough from an intake 106 adjacent to a joint structure 108. Each divergent flap 56 may be described as having a length between a forward end section 112 and an aft end section 114, and a width between a first longitudinal side 118 and a second longitudinal side 120. The forward end section 112 of each divergent flap 56 includes the joint structure 108 that forms a portion of the joint 58. The joint structure 108 corresponds with the divergent flap seal joint structure 82 along the hinge axis H.

The aft end section 114 of each divergent flap 56 may include a plow tip section 122 with a multiple of channels 124 that receive the cooling airflow C from one or more channels 104 within the divergent flap 56 to discharge the cooling airflow from the plow tip section 122. It should be understood that separate or integral tip sections of various shapes and configurations will benefit herefrom. The plow tip section 122 may be chiseled and includes a hinge point 126 for attachment of an external flap 128 (FIG. 9).

At least one or a subset of the divergent flaps 56 in the divergent section 46 includes a passive tangential ejector (PTE) 130. The PTE 130 generally includes an ejector door 132 that is pressure balanced at a hinge 134 within the divergent flap inner skin 100. It should be appreciated that the divergent flaps 56 may be solid and the divergent flap inner skin 100 as defined here may alternatively be a surface. Furthermore, the PTE 130 may be located within the divergent flap seal body 78.

The ejector door 132 may define a profile that is generally the same as the divergent flap 56. That is, the ejector door 132 may include a chiseled aft end section 136. It should be appreciated that various shapes may alternatively or additionally be provided.

The hinge 134 defines a PTE axis P transverse to the engine axis A and located to define a desired pressure balance between the secondary airflow S and the core primary airflow C. That is, the hinge 134 may be located at the upstream edge of the flap (as shown), or at an upstream section 138 of the ejector door 130 such that the delta pressure between the secondary airflow S within the divergent flaps 54 and the core primary airflow C passively actuates the ejector door 130 at a defined overexpanded condition. It should be appreciated that hinge as defined herein includes various hinges, pivots and flexible members.

In an overexpanded condition, the static pressure within the nozzle system 34 due to the core primary airflow C is less than the ambient static pressure. The overexpanded condition may be imposed by the operating conditions of the nozzle system 34 (nozzle pressure ratio (NPR)). There is a single ideal expansion condition where the ambient air pressure is equal to the pressure that exists when the flow expands ideally to the exit. Below this NPR, the nozzle is overexpanded and a favorable pressure gradient is formed. The PTE 130 takes advantage of the characteristics of an overexpanded nozzle to bring flow into the divergent section 46 to reduce the effective area ratio to closer to ideal. This changes the exhaust plume characteristics and increases thrust at the condition of interest over that which would occur without the PTE 130. The flow will not expand beyond ideal, because as ambient air is introduced, the pressure increases to drive the pressure gradient towards zero.

The pressure balance is set with respect to the delta pressure between the secondary airflow S (behind the flap) and the core primary airflow C. When the pressure of the secondary airflow S is sufficiently high with respect to the pressure of the core primary airflow C, the ejector door 132 opens to entrain secondary airflow S into the divergent section 46 of the nozzle system 34 (FIG. 9). The ejector door 132 provides minimal disruption to the core primary airflow with minimal loss of thrust potential.

In another disclosed non-limiting embodiment, the pressure balance may also be set with a mechanical bias 136 such as a spring, leaf, bias or other system.

As the ejector door 132 is mounted flush with the divergent flap inner skin 100 when in the closed position, the PTE 130 is readily applicable to arbitrarily shaped nozzles such as 2D and high aspect ratio nozzles. When closed, the ejector door 132 has minimal—if any—impact on performance.

The PTE 130 also enhances the performance of fixed exit area, variable throat area nozzle systems 34. The PTE 130 enhances performance of the nozzle system 34 through over-expansion capability, plume tailoring, acoustic performance, and thermal cooling. The relatively significant axial extent of the ejector door 132 entrains a significant quantity of secondary airflow S at less loss than typical axial station ejectors. As discussed, the flow of secondary airflow during operation of the engine in an overexpanded condition advantageously allows plume tailoring and increases thrust. This also advantageously reduces loads on hardware and saves weight. The introduction of secondary air through the PTE 130 can also favorably impact jet noise and unsteady pressure loading in and aft of the divergent section 46 of the nozzle system 34. The nozzle system 34 may be also operated in an overexpanded condition during STOVL operations, where still another advantage is that the exhaust plume can be tailored to reduce hot gas ingestion into the aircraft inlet.

It should be understood that like reference numerals identify corresponding or similar elements throughout the several drawings. It should also be understood that although a particular component arrangement is disclosed in the illustrated embodiment, other arrangements will benefit herefrom.

Although the different non-limiting embodiments have specific illustrated components, the embodiments of this invention are not limited to those particular combinations. It is possible to use some of the components or features from any of the non-limiting embodiments in combination with features or components from any of the other non-limiting embodiments.

Although particular step sequences are shown, described, and claimed, it should be understood that steps may be performed in any order, separated or combined unless otherwise indicated and will still benefit from the present disclosure.

The foregoing description is exemplary rather than defined by the limitations within Various non-limiting embodiments are disclosed herein, however, one of ordinary skill in the art would recognize that various modifications and variations in light of the above teachings will fall within the scope of the appended claims. It is therefore to be understood that within the scope of the appended claims, the disclosure may be practiced other than as specifically described. For that reason the appended claims should be studied to determine true scope and content.

What is claimed is:

1. A convergent/divergent nozzle system comprising:
an inner skin; and
an ejector door movably mounted to said inner skin at a hinge.

2. The system as recited in claim 1, wherein said ejector door is pressure balanced to open when a pressure of a secondary airflow is greater than a pressure of the core primary airflow.

3. The system as recited in claim 1, wherein said ejector door is mechanically biased.

4. The system as recited in claim 1, wherein said ejector door include a chiseled aft end section.

5. The system as recited in claim 1, further comprising an outer skin mounted to said inner skin to define a flowpath therethrough.

6. A convergent/divergent nozzle system comprising:
a convergent section; and
a divergent section downstream of said convergent section, said divergent section includes a passive tangential ejector.

7. The convergent/divergent nozzle system as recited in claim 6, wherein said divergent section is axisymmetric.

8. The convergent/divergent nozzle system as recited in claim 6, wherein said passive tangential ejector includes a passive tangential ejector in at least one divergent flap of said divergent section.

9. The convergent/divergent nozzle system as recited in claim 8, wherein said passive tangential ejector includes an ejector door with a chiseled aft end section.

10. The convergent/divergent nozzle system as recited in claim 6, wherein said passive tangential ejector is one of a multiple of passive tangential ejectors, each of said multiple of passive tangential ejectors is located in each of a multiple of divergent flaps of said divergent section.

11. The convergent/divergent nozzle system as recited in claim 10, wherein said passive tangential ejector includes an ejector door with a chiseled aft end section.

12. The convergent/divergent nozzle system as recited in claim 11, wherein said ejector door is mechanically biased.

13. The convergent/divergent nozzle system as recited in claim 6, wherein said passive tangential ejector is one of a multiple of passive tangential ejectors, each of said multiple of passive tangential ejectors is located in each of a multiple of divergent flaps of said divergent section.

14. A method of operating a convergent/divergent nozzle system comprising:
opening a divergent section of the convergent/divergent nozzle system to a secondary airflow.

15. The method as recited in claim 14, further comprising:
communicating ambient airflow as the secondary airflow.

16. The method as recited in claim 14, further comprising:
communicating fan airflow as the secondary airflow.

17. The method as recited in claim 14, further comprising:
communicating third stream airflow as the secondary airflow.

18. The method as recited in claim 14, further comprising:
opening a passive tangential ejector within the divergent section.

19. The method as recited in claim 14, further comprising:
opening a passive tangential ejector within a divergent flap of the divergent section.

20. The method as recited in claim 14, further comprising:
pressure balancing a passive tangential ejector within the divergent section between a core primary airflow and the secondary airflow.
